(19) United States
(12) Patent Application Publication
(10) Pub. No.: US 2019/0010038 A1
(43) Pub. Date: Jan. 10, 2019

(54) BOTTLE OPENER AND METHODS TO USE THE SAME

(71) Applicant: Taylor Precision Products, Inc., Seattle, WA (US)

(72) Inventors: Leif Erickson, Seattle, WA (US); Joe Gray, Seattle, WA (US); Madeleine Busch, Seattle, WA (US)

(21) Appl. No.: 16/025,254

(22) Filed: Jul. 2, 2018

Related U.S. Application Data
(60) Provisional application No. 62/528,910, filed on Jul. 5, 2017.

(51) Int. Cl. B67B 7/04

(52) U.S. Cl. CPC B67B 7/0441

(57) ABSTRACT

A bottle cap opener can include a drive assembly having knuckle body having a rack gear, and a pinion coupled to the rack gear, where rotary movement of the rack gear can cause translation of the pinion. The bottle cap opener can also include a worm assembly coupled to the drive assembly, the worm assembly including a cork screw that is configured to remove a bottle cap; and a handle assembly having a handle, where the handle can be coupled to the knuckle body to rotatably move with the knuckle body about a first pivot axis and rotatably move relative to the knuckle body about a second pivot axis. Related methods are also provided.

### BACKGROUND

### Technical Field

The present disclosure is generally related to bottle openers and, more particularly, to wine bottle openers.

### Description of the Related Art

Devices used to extract corks from bottles and, specifically, wine bottles, are ubiquitous. In general, such devices have a large foot print that reduces the portability and ability to store such devices in a compact manner. For example, such devices have handles that function as levers and protrude out from a body of the cork screw extractor device. Such structures, including extensions of handles, limit the ability of users, such as waiters, to effectively carry cork extractor devices due to the large foot print. Further, storing such cork extractor devices requires using more space than desired. Accordingly, a cork extractor or, more generally, a bottle cap opener, which can be portable with ease and is compact to allow ease of storage, is desirable.

### BRIEF SUMMARY

The various implementations of bottle cap openers and related methods described herein provide for bottle cap openers having robust, compact, and efficient form factors. For example, in one non-limiting implementation, a bottle cap opener can be summarized as comprising a drive assembly including a knuckle body having a rack gear; and a pinion coupled to the rack gear, rotary movement of the rack gear causing translation of the pinion. The bottle cap opener can also comprise a worm assembly coupled to the drive assembly, the worm assembly including a cork screw that is configured to remove a bottle cap; and a handle assembly having a handle, the handle coupled to the knuckle body to rotatably move with the knuckle body about a first pivot axis and rotatably move relative to the knuckle body about a second pivot axis.

For example, in another non-limiting implementation, a bottle cap opener having a use configuration and a storage configuration can be summarized as comprising a drive assembly including a knuckle body having a rack gear; and a pinion coupled to the rack gear, rotary movement of the rack gear causing translation of the pinion. The bottle cap opener can also comprise a worm assembly coupled to the drive assembly, the worm assembly including a cork screw that is configured to remove a bottle cap; and a handle assembly having a handle, the handle coupled to the knuckle body to rotatably move with the knuckle body about a first pivot axis in the use configuration and rotatably move relative to the knuckle body about a second pivot axis from the use configuration to the storage configuration.

For example, in another non-limiting implementation, a method can be summarized as comprising removing a bottle cap of a bottle via a rack and gear mechanism of a bottle cap opener by driving a cork screw, at least partially, into the bottle cap, the removing including rotating a handle about a first pivot axis; and moving the bottle cap opener to a storage configuration by rotating the handle about a second pivot axis.

### BRIEF DESCRIPTION OF THE SEVERAL VIEWS OF THE DRAWINGS

FIG. 1 is a perspective view of a bottle cap opener, according to one example, non-limiting implementation.

FIG. 2 is an exploded view of the bottle cap opener of FIG. 1.

FIG. 3 is a side view of the bottle cap opener of FIG. 1.

FIG. 4 is a cross-sectional view of the bottle cap opener of FIG. 1, taken along lines 4-4.

FIG. 5 is a cross-sectional view of the bottle cap opener of FIG. 1, taken along lines 5-5.

FIG. 6 is a side view of the bottle cap opener of FIG. 1, with certain components removed for clarity of illustration and description.

FIG. 7 is a cross-sectional view of the bottle cap opener of FIG. 1, taken along lines 7-7.

FIG. 8 is a side view of the bottle cap opener of FIG. 1, illustrating the bottle cap opener in a stored configuration.

### DETAILED DESCRIPTION

In the following description, certain specific details are set forth in order to provide a thorough understanding of various disclosed implementations. One skilled in the relevant art will recognize that implementations may be practiced without one or more of these specific details. In other instances, well-known structures and devices associated with bottle cap openers and related apparatuses, systems, and methods may not be shown or described in detail to avoid unnecessarily obscuring descriptions of the implementations.

Unless the context requires otherwise, throughout the specification and claims which follow, the word “comprise” and variations thereof, such as “comprises” and “comprising,” are to be construed in an open, inclusive sense, that is, as “including, but not limited to.”

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

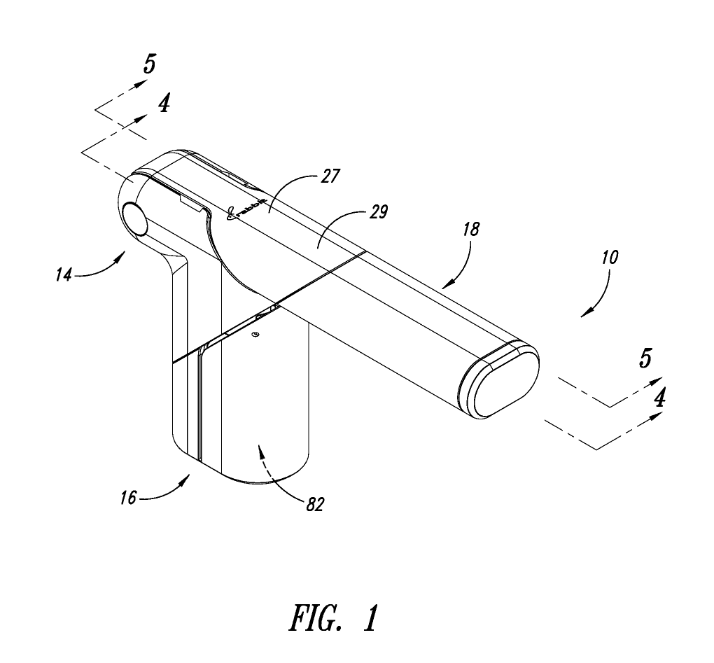

FIGS. 1 through 8 illustrate a bottle cap opener 10 according to one example, non-limiting implementation. The bottle cap opener 10 is generally configured to open a wide variety of bottles, in particular, wine bottles having a cork. The bottle cap opener 10 includes a worm assembly 12, a drive assembly 14, a body assembly 16, and a handle assembly 18. The worm assembly 12 includes a cork screw 19 that has generally helical-shape with a pointed edge 20 that is sized and shaped to at least partially penetrate a cork or other bottle closing element. The worm assembly 12 also includes a worm cap 21 that is coupled to the cork screw 19. In particular, the worm cap 21 includes a worm shaft 22 that includes a threaded surface 23 that is sized and shaped to couple to the cork screw 19. The worm assembly 12 also includes a worm top cap 24. The worm top cap 24 includes an interior cavity 25 that is sized and shaped to receive the worm cap 21. The worm top cap 24 also includes an interior coupling surface 26 that is sized and shaped to threadedly couple to the drive assembly 14, as described in more detail below.

The drive assembly 14 generally includes a rack and pinion mechanism that drives the worm assembly 12 such that the cork screw 19 can at least partially penetrate a bottle cap and couple thereto, remove the bottle cap from the bottle, and thereafter expel or decouple the bottle cap from the cork screw 19. The drive assembly 14 includes a knuckle body 27 that includes a rack gear 28 located at one end of the knuckle body 27 and a pivot portion 29 located at another end of the knuckle body 27. The pivot portion 29 includes a pivot pin recess 30 and a pair of bearing recesses 31. The pivot pin recess 30 and the pair of bearing recesses 31 are sized and shaped to coupleably receive portions of the handle assembly 18, as described in further detail below. The rack gear 28 includes a gear aperture 32 that is sized and shaped to pivotably receive a gear pin assembly 33 about which the rack gear 28 rotates. In particular, the rack gear 28 includes rack teeth 34 that are sized and shaped to couple to and mesh with a pinion member 35 of the drive assembly 14.

The pinion member 35 includes a pinion body 36 having pinion teeth 37 that are sized and shaped to couple to and mesh with the rack teeth 34 of the rack gear 28. In this manner, when the rack gear 28 pivotably rotates, the rack teeth 34 engage with the pinion teeth 37 and drive and/or translate the pinion member 35 and the cork screw 19 of the worm assembly 12. In particular, the pinion body 36 includes a worm coupling portion 38 that includes a cork screw aperture 39 extending therethrough. The cork screw aperture 39 is sized and shaped to receive therethrough the cork screw 19. The worm coupling portion 38 also includes a worm coupling shaft 40 that is sized and shaped to couple the pinion member 35 to the worm assembly 12. In particular, the worm coupling shaft 40 includes a worm coupling surface 41 that is sized and shaped to threadedly couple to the interior coupling surface 26 of the worm top cap 24. In this manner, when the pinion member 35 translates or slideably moves the worm assembly 12, in particular, the cork screw 19 translates or slideably moves therewith. The pinion body 36 also includes a slide shaft 42 that includes recesses 43. Each recess 43 is positioned on a side of the slide shaft 42 and is sized and shaped to facilitate slideable translation or movement of the worm assembly 12, as described in further detail below.

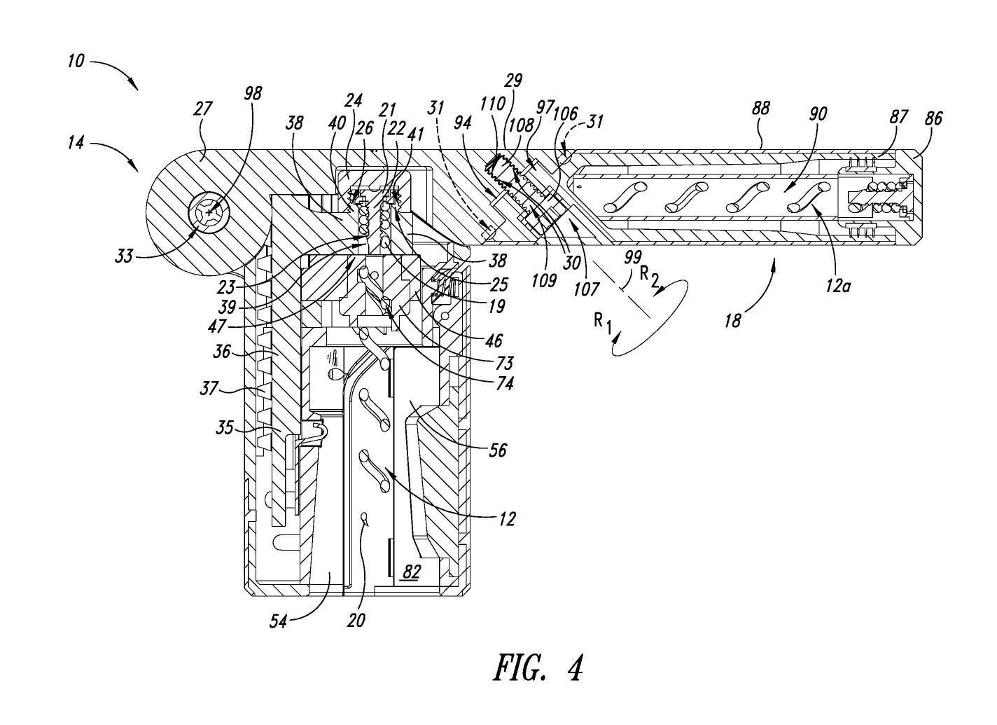

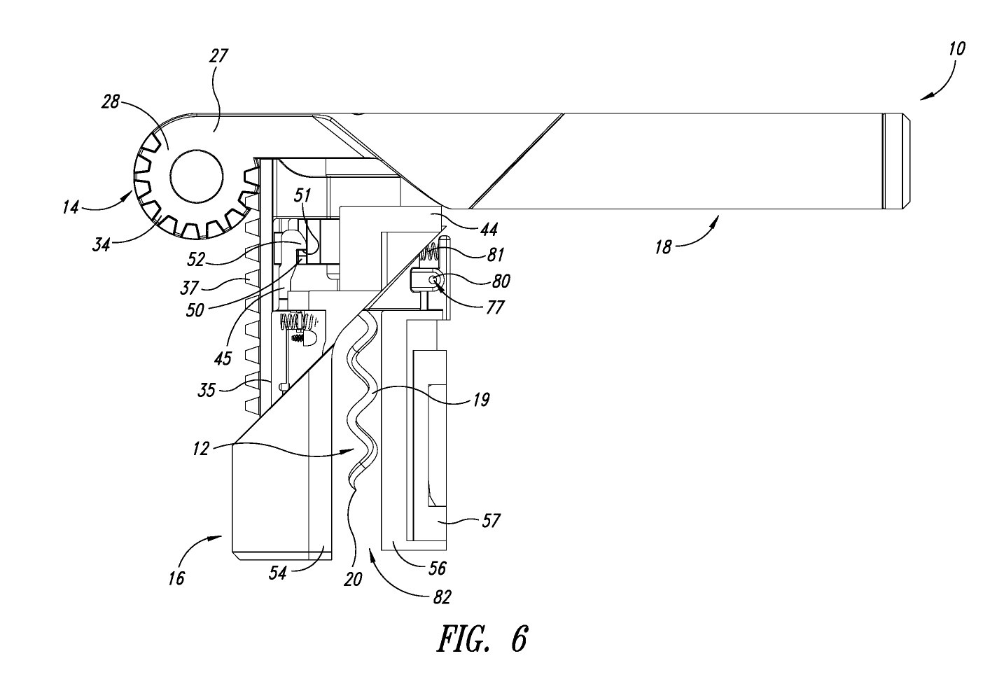

The drive assembly 14 also includes a travel member 44 and a travel latch 45. The travel member 44 includes a worm shaft 46 that has a worm aperture 47 sized and shaped to receive therethrough the cork screw 19. As illustrated in FIG. 4, the worm shaft 46 is coupled to the worm coupling portion 38. The travel member 44 includes slide flange 48 with a recess 49 that is sized and shaped to slideably couple the travel member 44 to the slide shaft 42 of the pinion body 36. The slide flange 48 also includes a pair of latch flanges 50 that extend outwardly from the slide shaft 42. As illustrated with particularity in FIG. 6, each latch flange 50 includes a receiving surface 51 that receives the travel latch 45. In particular, the travel latch 45 includes a pair of hooks 52 that couple to or latch on to the corresponding latch flange 50. Thus, when the knuckle body 27 is pivotably rotated at a counterclockwise direction, for example, the rack gear 28 rotates therewith and the rack teeth 34 engage with the pinion teeth 37 to drive the pinion member 35. As the latch flanges 50 of the travel member 44 contact the pair of hooks 52 and the knuckle body 27 continues to rotate in the counterclockwise direction, the worm assembly 14 and, more specifically, the cork screw 19 slideably translates and moves outwardly through the worm aperture 47.

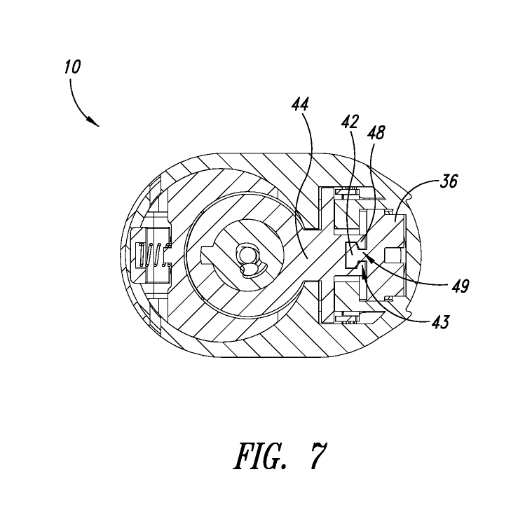

When the knuckle body 27 moves in a clockwise direction, for example, the rack gear 28 rotates therewith and the rack teeth 34 engage with the pinion teeth 37 to drive the pinion member 35. As the pinion member 35 slideably translates, as illustrated with particularity in FIG. 7, the slide flange 48 moves along the recesses of the slide shaft 42, and the worm assembly 12, specifically, the cork screw 19 translates to allow penetration and coupling to a bottle cap.

The body assembly 16 includes a main body 53, an inner body cover 54, a main body cover 55, an alignment cover 56, an alignment pad 57, an alignment body cover 58, and an exterior cover 59. Each component of the body assembly 16, including the main body 53, the inner body cover 54, the main body cover 55, the alignment cover 56, the alignment pad 57, the alignment body cover 58, and the exterior cover 59, can be coupled other components of the body assembly 16 via fasteners, welds, adhesives, or other suitable coupling structures.

The main body 53 includes an upper portion 60 having a pair of side flanges 61 spaced apart to define a rack and pinion receiving region 62. The rack and pinion receiving region 62 is sized and shaped to receive the knuckle body 27 and the pinion member 35. In particular, each side flange 61 includes a knuckle aperture 63 that is sized and shaped to receive the pin assembly 33, which pivotably rotatably couples the knuckle body 27 to the main body 53. The upper portion 60 of the main body 53 also includes pinion recess 64 that extends therethrough. The pinion recess 64 is sized and shaped to receive the pinion member 35, as the pinion member 35 is received in the rack and pinion receiving region 62. The upper portion 60 also includes an inner body receiving portion 66 which is generally hollow to define an inner body receiving region 67 that is sized and shaped to receive the inner body cover 54. A lower portion 68 of the main body 53 includes a recess 69 that is sized and shaped to coupleably seat or receive the main body cover 55 when the main body cover 55 is coupled to the main body 53. The main body cover 55 can be coupled to the main body 53 via fasteners, adhesives, welds, or other suitable coupling structures.

As described above, the inner body cover 54 is received in the inner body receiving region 67 of the main body 53. In particular, the inner body cover 54 includes a lower wall 70 that is received in an interior side of the lower portion 68 of the main body 53. The inner body cover 54 also includes an upper inner body portion 71 that is generally hollow and sized and shaped to be received in the inner body receiving portion 67. Thus, as the pinion member 35 is received in the pinion recess 64 of the main body 53, the worm coupling shaft 40 is located in the hollow inner body receiving region 67 of the main body 53 and the hollow upper inner body portion 71, which generally define a path through which the cork screw 19 can travel. In some implementations, the bottle cap opener 10 can optionally include an alignment insert 73. The alignment insert 73 has a generally cylindrically-shaped structure that is sized and shaped to be received in the travel member 44. The alignment insert 73 includes an interior cork screw surface 74 that is sized and shaped to receive the cork screw 19. As the cork screw 19 is received in the interior cork screw surface 74, the cork screw 19 moves in a controlled and an aligned manner.

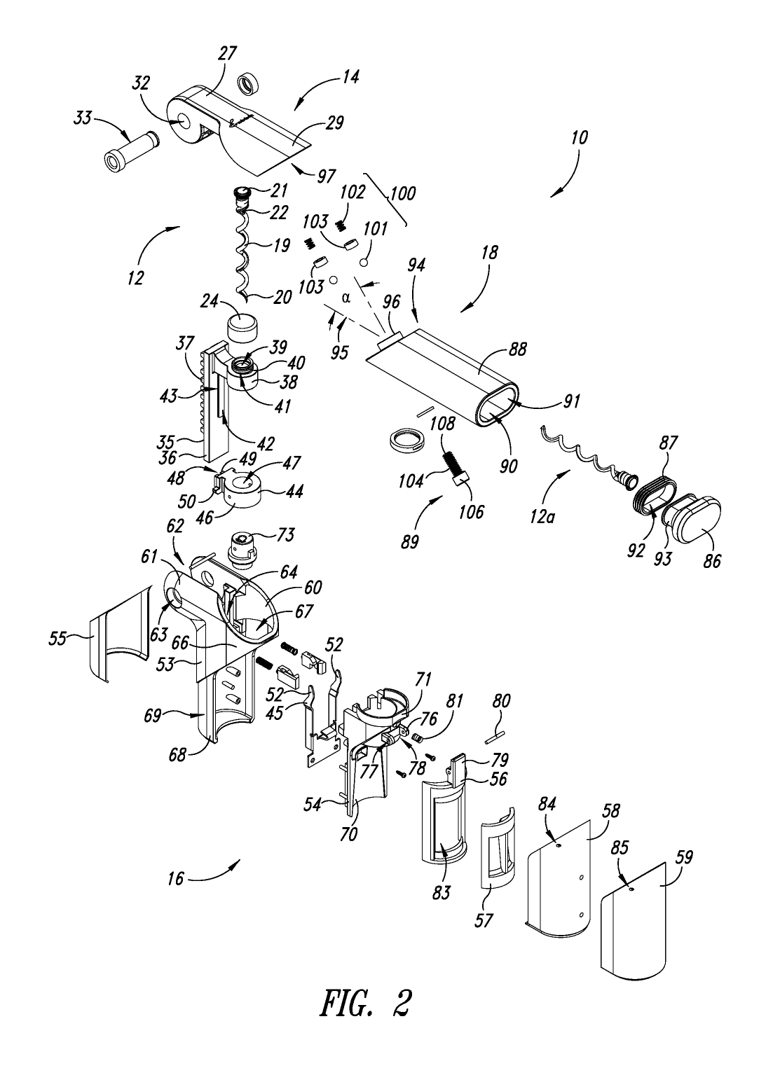

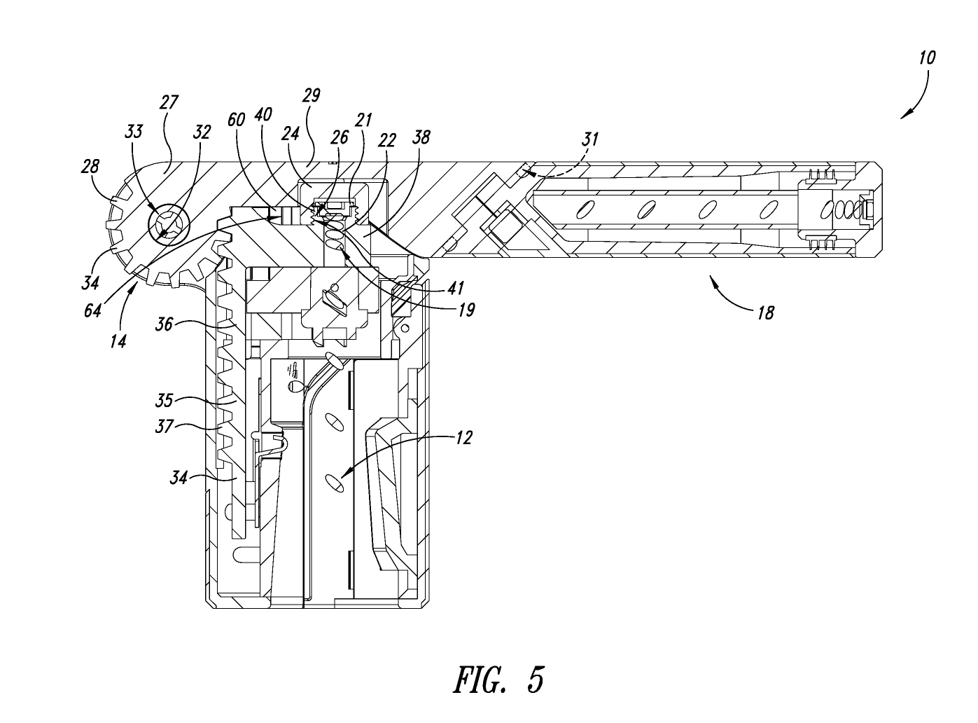

As illustrated in FIGS. 2 and 6, the inner body cover 54 includes a clevis portion 76 that includes an alignment aperture 77 and an alignment cover receiving region 78. The alignment cover receiving region 78 is sized and shaped to pivotably coupleably receive a portion of the alignment cover 56. In particular, the alignment cover 56 includes a lug portion 79 that extends upwardly from a body of the alignment cover 56. The lug portion 79 is pivotably coupleably received in the alignment cover receiving region 78 with a pin 80 pivotably coupling the lug portion 79 to the clevis portion 76. Thus, in this manner, the alignment cover 56 can be pivotably moved relative to the inner body cover 54 via the pin 80. As illustrated in FIGS. 2 and 5, when the alignment cover 56 is pivotably coupled to the inner body cover 54 as described above, an interior surface of the inner body cover 54 is spaced apart from an interior surface of the alignment cover 56 to define a bottle neck receiving region 82. The bottle neck receiving region 82 is generally sized and shaped to allow a bottle neck being received therein to provide the worm assembly 12 access to the bottle cap. As the alignment cover 56 is pivotably rotatably coupled to the inner body cover 54, the alignment cover 56 can be pivotably rotated to clamp or release the bottle neck or any other portion of the bottle during use. In some implementations, a biasing device 81, e.g., a spring, can be provided which urges the alignment cover 56 away from the inner body cover 54, e.g., in a non-clamp or release position.

The alignment cover 56 includes a pad recess 83 extending partially through an exterior surface of the alignment cover 56, which pad recess 83 is sized and shaped to receive the alignment pad 57. The alignment body cover 58 is sized and shaped to overlie the alignment pad 57 and couple to the alignment cover 57. The alignment body cover 58 includes a pin aperture 84 that extends therethrough, which pin aperture 84 is sized and shaped to pivotably coupleably receive the pin 80. In this manner, the alignment body cover 58 along with the alignment cover 56 can pivotably rotate relative to the inner body cover 54 about pin 80. The exterior cover 59 is sized and shaped to overlie the alignment body cover 58 and couple thereto. The exterior cover 58 also includes an exterior cover pin aperture 85 that extends therethrough, which exterior cover pin aperture 85 is sized and shaped to pivotably coupleable receive the pin 80. Again, in this manner, the exterior cover 59 along with the alignment body cover 58 and the alignment cover 56 can pivotably rotate relative to the inner body cover 54 about the pin 80.

The handle assembly 18 includes a handle cap 86, a gasket 87, a handle 88, and a pivot assembly 89. The handle 88 includes an internal cavity 90 that is sized and shaped to receive a spare worm assembly, for example, worm assembly 12a. An opening 91 of the handle 88 is defined at least in part by the internal cavity 90 that is disposed at one end of the handle 88, which opening 91 is sized and shaped to receive the gasket 87. The gasket 87 has a cap opening 92 which extends through a body of the gasket 87. The cap opening 92 is sized and shaped to removeably coupleably receive a connection portion 93 of the handle cap 86. Thus, in this manner, the handle 88 can be used as an additional storage compartment for one or more spare worm assemblies, e.g., worm assembly 12a, and can be accessed via the handle cap 86 removeably coupled to the handle 88 via the gasket 87.

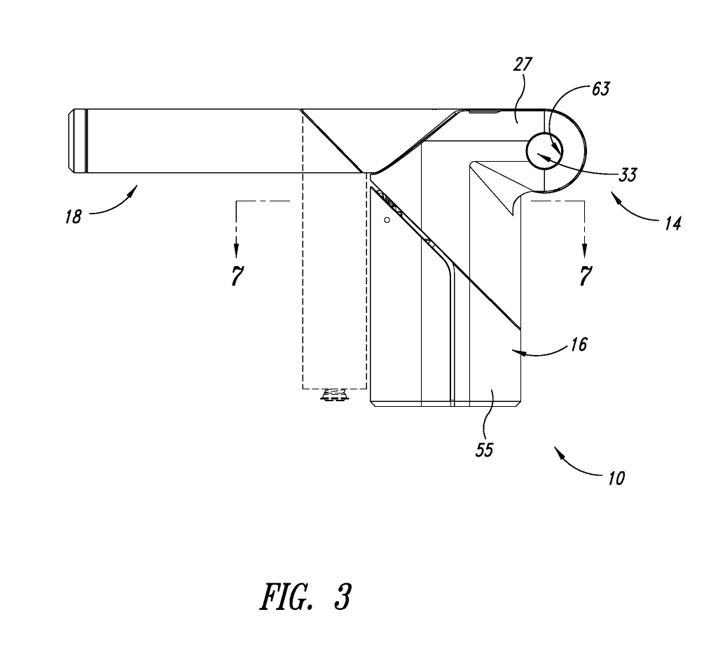

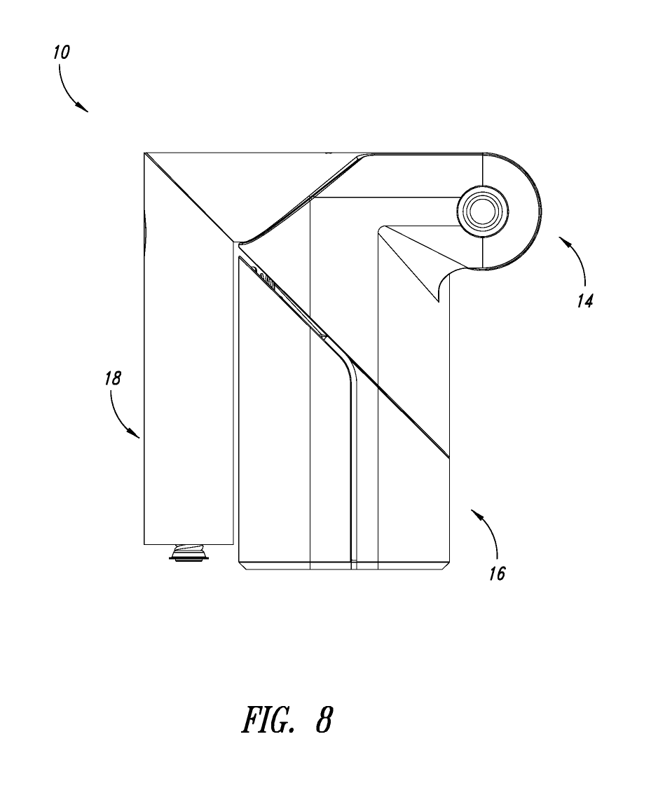

The handle 88 includes an end surface 94 that extends angularly relative to a central axis 95 of the handle 88 at an angle α. In some implementations, the angle α can be in a range of between 30 to 60 degrees. The handle 88 includes a protrusion 96 that extends outwardly from the end surface 94 in a direction substantially perpendicular to the end surface 94. The protrusion 96 is sized and shaped to be pivotably coupleably received by a receiving aperture 97 of the knuckle body 27. In particular, the handle 88 is pivotably coupled to the knuckle body 27 via the pivot assembly 89 such that the handle 88 can pivotably rotate with the knuckle body 27 in clockwise or counterclockwise directions along a first pivot axis 98 and the handle 88 can pivotably rotate with respect to the knuckle body 27 along a second pivot axis 99 in first and second rotary directions R1, R2. The pivot assembly 88 includes a pair of bearing assemblies 100, each having a pivot ball 101, pivot spring 102, a bushing 103, and a pivot pin 104. Each bearing assembly 100 is coupleably received in the bearing recesses 31 disposed in the knuckle body 27, which bearing recesses 31 are sized and shaped to receive the bearing assembly 100. The pivot pin 104 has a cap portion 106 that is received in a cap recess 107 of the handle 88 and a shaft portion 108 that is received in and through a shaft portion recess 109 disposed in the protrusion 96 and a pin recess 110 disposed in the knuckle body 27. Moreover, as illustrated in FIG. 4, the cap recess 107, the shaft portion recess 109, and the pin recess 110 are substantially coaxial with the second pivot axis 99. Thus, the handle 88 can pivotably rotate about the second pivot axis 99 via the pivot pin 104 from a use position illustrated in FIGS. 1, 3, 4, 5, and 6 to a storage position illustrated in phantom lines in FIG. 3 and solid lines in FIG. 8.

Thus, in operation, a user can move the handle 88 from the storage position (e.g., FIG. 8) to the use position (e.g., FIG. 1). In the use position, the user can rotate the handle 88 in a counterclockwise direction, for example, to rotate the rack gear 28, which causes the rack teeth 34 to engage the pinion teeth 37 of the pinion member 35 and drive the worm assembly 12 outwardly from the inner body receiving region 67 of the main body 53. As the handle assembly 18 is fixedly coupled to the knuckle body 27 to rotate about the gear pin assembly 33 in the clockwise and counterclockwise directions, the handle 88 rotates with the knuckle body 27. The user can position a bottle neck in the neck receiving region 82 with the alignment cover 56 moved away from the inner body cover 54 via the biasing device 81. Once the bottle neck is positioned in the neck receiving region 82, the user can press or move the alignment cover 56 toward the inner body cover 54 and clamp the bottle neck by overcoming the biasing force of the biasing device 81.

Thereafter, the user can rotate the handle 88 and the knuckle body 27 in the clockwise direction to drive the pinion member 35 and the worm assembly 12 toward the bottle cap, which causes the cork screw 19 to at least partially penetrate the bottle cap 19 and couple thereto. Once the cork screw 19 is coupled to the bottle cap, the user can unclamp the alignment cover 56 by removing force applied thereto, which causes the biasing device 81 to urge the alignment cover 56 away from the inner body cover 54. The user can rotate the handle 88 and the knuckle body 27 in the counterclockwise direction to drive the pinion member 35 and the worm assembly 12 toward and out of the inner body receiving region 67 of the main body 53, which causes the cork screw 19 to decouple or remove the bottle cap from the bottle. Thereafter, the user can remove the bottle from the bottle cap opener 10. To remove the bottle cap from the cork screw 19, the user can rotate the handle 88 and the knuckle body 27 in the clockwise direction to drive the pinion member 35 and the worm assembly 12 with the bottle cap coupled to the cork screw 19 into the inner body receiving region 67 of the main body 53. The user can thereafter press or move the alignment cover 56 toward the inner body cover 54 and clamp the bottle cap coupled to the cork screw 19 by overcoming the biasing force of the biasing device 81, and rotate the handle 88 and the knuckle body 27 in the counterclockwise direction to drive the pinion member 35 and the worm assembly 12 toward and out of the inner body receiving region 67 of the main body 53. Movement of the worm assembly 12 in this manner decouples or removes the bottle cap from the cork screw 19. Once use of the bottle cap opener 10 is completed, the user can rotate the handle 88 relative to the knuckle body 27 about the second pivot axis 99 in rotary direction R1 to move the bottle cap opener 10 to a storage configuration, with the handle 88 in the storage position.

Moreover, the various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A bottle cap opener, comprising:
a drive assembly including:
a knuckle body having a rack gear; and
a pinion coupled to the rack gear, rotary movement of the rack gear causing translation of the pinion;
a worm assembly coupled to the drive assembly, the worm assembly including a cork screw that is configured to remove a bottle cap; and
a handle assembly having a handle, the handle coupled to the knuckle body to rotatably move with the knuckle body about a first pivot axis and rotatably move relative to the knuckle body about a second pivot axis.

2. The bottle cap opener of claim 1 wherein the handle includes an end surface that is oriented angularly relative to a central axis of the handle at an angle α.

3. The bottle cap opener of the claim 2 wherein the handle includes a protrusion that protrudes from the end surface at the angle α.

4. The bottle cap opener of claim 3 wherein the knuckle body includes a receiving aperture that extends in the knuckle body at the angle α and is sized and shaped to coupleably receive the protrusion.

5. The bottle cap opener of claim 1 wherein the handle assembly includes a pivot assembly that pivotably couples the handle to the knuckle body such that the handle is rotatably moveable relative to the knuckle body about the second axis.

6. The bottle cap opener of claim 5 wherein the pivot assembly includes a pivot pin that pivotably couples the handle to the knuckle body, the pivot pin angularly oriented relative to a central axis of the handle.

7. The bottle cap opener of claim 5 wherein the pivot assembly includes at least one bearing assembly that is coupled to one of the handle or the knuckle body.

8. The bottle cap opener of claim 1 wherein the handle includes a recess sized and shaped to receive a spare worm assembly.

9. A bottle cap opener having a use configuration and a storage configuration, the bottle cap opener comprising:
a drive assembly including:
a knuckle body having a rack gear; and
a pinion coupled to the rack gear, rotary movement of the rack gear causing translation of the pinion;
a worm assembly coupled to the drive assembly, the worm assembly including a cork screw that is configured to remove a bottle cap; and
a handle assembly having a handle, the handle coupled to the knuckle body to rotatably move with the knuckle body about a first pivot axis in the use configuration and rotatably move relative to the knuckle body about a second pivot axis from the use configuration to the storage configuration.

10. The bottle cap opener of claim 9 wherein the handle includes an end surface that is oriented angularly relative to a central axis of the handle at an angle α.

11. The bottle cap opener of claim 10 wherein the knuckle body includes a receiving aperture that extends in the knuckle body at the angle α and is sized and shaped to coupleably receive a protrusion disposed on the handle.

12. The bottle cap opener of claim 9 wherein the handle assembly includes a pivot assembly that pivotably couples the handle to the knuckle body such that the handle is rotatably moveable relative to the knuckle body about the second axis.

13. The bottle cap opener of claim 1 wherein the handle includes a recess sized and shaped to receive a spare worm assembly.

14. A method, comprising:
removing a bottle cap of a bottle via a rack and gear mechanism of a bottle cap opener by driving a cork screw, at least partially, into the bottle cap, the removing including;
rotating a handle about a first pivot axis; and
moving the bottle cap opener to a storage configuration by rotating the handle about a second pivot axis.

15. The method of claim 14, further comprising:
providing a recess in the handle, the recess sized and shaped to receive a spare cork screw.
